(19) United States
(12) Patent Application Publication
(10) Pub. No.: US 2006/0095598 A1
(43) Pub. Date: May 4, 2006

(54) Method and apparatus of extending answer to reset and subsequent communications between a smart card and a chip card interface device

(75) Inventors: Sylvain Prevost, Austin, TX (US); Bart Bombay, Austin, TX (US)

Correspondence Address: ANDERSON & JANSSON L.L.P., 9501 N. CAPITAL OF TX HWY #202, AUSTIN, TX, 78759, US

(73) Assignee: Axalto Inc., Austin, TX (US)

(21) Appl. No.: 10/978,058

(22) Filed: Oct. 30, 2004

(51) Int. Cl. G06F 3/00

(52) U.S. Cl. 710/10

(57) ABSTRACT

A smart card having the capability during execution of an initialization process to allow concurrent processing of a second process consisting of distinct computational units having deadlines associated therewith and a method for operating such a smart card. The smart card has logic to initiate the second process and to execute a unit of the second process, logic to initiate the initialization process, logic to periodically pause the initialization process to allow the second process to process a computational unit before any required deadline for completing the computational unit, and logic to executing the second process processing a computational unit during the pauses of the initialization process.

### BACKGROUND OF THE INVENTION

1.0 Field of the Invention

The present invention relates generally to concurrent processing of two or more processes on a smart card and more particularly to a mechanism for extending the answer-to-reset processing to accommodate longer initialization sequences.

2.0 Description of the Related Art

Smart cards are small personal computing devices that are used to protect very sensitive information. Smart cards may be used to perform banking functions, provide access to health records, personalization of computer network access, secure building access, and many more functions. Smart cards are also used as subscriber identity modules (SIM) in certain mobile telephony networks.

Smart cards provide all their usefulness by being connected in some manner to other computing devices. Usually, a smart card is connected to a computer via a chip card interface device (CCID, also referred to herein as a card reader), which in turn is connected to the computer. The smart card may be either a smart card with electrical contacts for connecting directly to the CCID or may be a contactless smart card in which the communication to the CCID is performed over a wireless connection. The ISO 7816 smart card standard provides specifications for smart cards with contacts and the ISO 14443 standard provides specifications for contactless smart cards.

Immediately after a smart card is powered up, e.g., after it has been inserted into a CCID, several things occur. These start up processes include an internal initialization sequence in which the smart card performs processes necessary to prepare it for whatever tasks are to follow. During startup, the smart card also starts the communication with the CCID by sending an answer-to-reset (ATR) sequence to the CCID to which the smart card is connected. Thirdly, the smart card and the CCID may also perform a protocol and parameters selection (PPS) negotiation as part of the start up process.

The ATR sequence consists of a sequence of characters (each, one byte of data), that inform the host about various characteristics of the card, e.g., transport protocol, transmission rate, serial number, mask version number. The ISO 7816 and ISO 14443 impose deadlines by which time the ATR sequence must begin. Unless the deadline is met, the CCID will usually abort communication with the smart card.

The ISO 7816 and ISO 14443 specifications also mandate that the smart card must be prepared to receive and process communication from the CCID as soon as the ATR transmission completes.

Smart cards typically must execute their initialization sequence quickly to meet the answer to reset (ATR) transmission-timing specifications. One way to accomplish this is to execute the initialization before starting the ATR transmission or by executing the initialization in parallel with the ATR transmission and ensuring that the initialization does not run beyond the ATR transmission. By having the initialization finish before the ATR transmission, the smart card will be ready to continue communication with the CCID at the point the ATR transmission is finished. The timing requirement—that the initialization finishes before the ATR transmission—is ensured by limiting the initialization so that it can conclude within a relatively short time period, for example, by having some fundamental card initialization finish before the beginning of the ATR transmission, and a lager portion of the card initialization finish before the completion of the ATR transmission.

However, such limits on how long the initialization may take inherently place limitations on what the initialization may accomplish prior to the point in time when the card must be ready to receive and process data from the CCID. That, in turn, limits what functions the smart card can perform because if the card is not initialized to perform a task, it cannot perform that task.

Accordingly, from the foregoing it is apparent that there is a hitherto unresolved need for a system and method wherein the smart card initialization sequence may be of arbitrary duration yet the smart card will still abide by specifications, particularly deadlines imposed by specifications, such as ISO 7816 and ISO 14443.

### BRIEF DESCRIPTION OF THE DRAWINGS

FIG. 1 is a schematic illustration of the operating environment in which a smart card according to the invention may be used to provide secure computing services.

FIG. 2 is a schematic illustration of an exemplary architecture of a resource-constrained device.

FIG. 3 is a schematic illustration of a software architecture for a resource-constrained device.

FIG. 4 is a timing sequence showing the typical start up sequence for a smart card.

FIG. 5 is a timing sequence diagram showing a modified start up sequence for a smart card according to the invention in which the card initialization sequence may be of arbitrary duration.

FIGS. 6a, 6b, and 6c form a flow-chart illustrating the operation of a smart card that supports the start up sequence according to the invention.

### DETAILED DESCRIPTION OF THE INVENTION

In the following detailed description and in the several figures of the drawings, like elements are identified with like reference numerals.

As shown in the drawings for purposes of illustration, the invention is embodied in a novel system and method for providing a mechanism in a smart card to allow for initialization processes of arbitrary duration. Existing smart cards and methods for operating smart cards have not allowed for initialization process of arbitrary duration because of timing deadlines required in communication with the chip card interface devices with which smart cards communicate.

A smart card according to the invention has logic to allow concurrent processing of two processes, a first process and a second process. The second process consists of distinct computational units that must be executed on prescribed intervals. The smart card initiates the second process and executing a unit of the second process. The card then transfers control to the first process and starts executing it. Periodically an interrupt is issued on the first process to allow the second process to process a computational unit before the required deadline for completing the computational unit; and during the pauses of the first process the smart card executes the second process processing a computational unit.

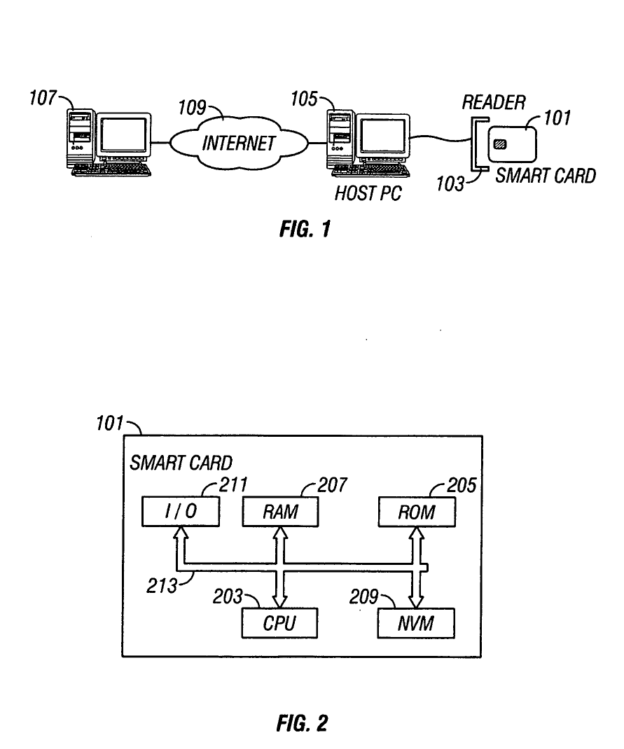

FIG. 1 is a schematic illustration of the operating environment in which a resource-constrained device according to the invention may be used to provide secure communication with a remote entity. A resource-constrained device 101, for example, a smart card, is connected to a computer network 109, for example, the Internet. The resource-constrained device 101 may be connected to the computer network 109 via a personal computer 105 that has attached thereto a CCID (also sometimes referred to herein as a card reader) 103 for accepting a smart card. However, the resource-constrained device 101 may be connected in a myriad of other ways to the computer network 104, for example, via wireless communication networks, smart card hubs, or directly to the computer network 109. The remote node 105 is a computer system of some sort capable to implement some functionality that may either seek access to information on the smart card 101 or to which the smart card user may seek access. For example, the remote node 107 may be executing banking software that a user of the smart card 101 is seeking to obtain access to. The smart card 101 may then provide some access control functionality or may even be an electronic purse to which funds are downloaded from the remote computer.

A smart card 101 is powered up when placed in contact with the card reader 103. The powering up of the smart card initiates certain processes discussed hereinbelow in greater detail.

The scenario of FIG. 1 is presented here merely for the purpose of providing an example and must not be taken to limit the scope of the invention whatsoever. Only the imagination of designers limits the myriad of possible deployment scenarios and uses for smart cards.

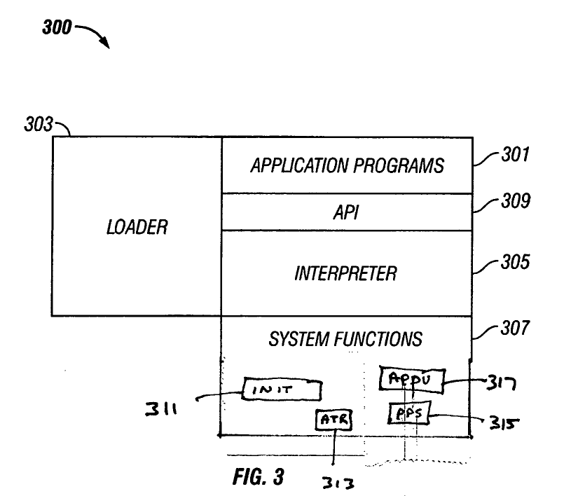

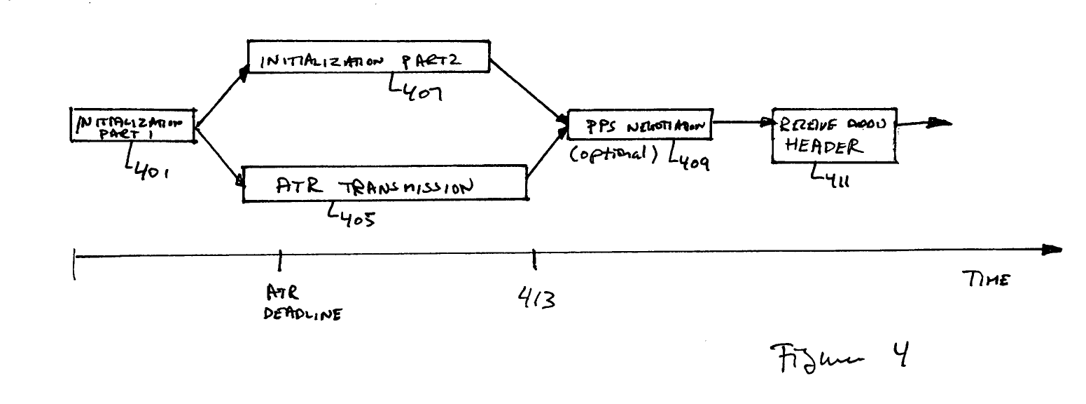

FIG. 2 is a schematic illustration of an exemplary architecture of a resource-constrained device 101. The resource-constrained device 101, e.g., a smart card has a central processing unit 203, a read-only memory (ROM) 205, a random access memory (RAM) 207, a non-volatile memory (NVM) 209, and a communications interface 211 for receiving input and placing output to a device, e.g., the card reader 103, to which the resource-constrained device 101 is connected. These various components are connected to one another, for example, by bus 213. In one embodiment of the invention, the initialization module 311, which is described in greater detail hereinbelow, as well as other software modules shown in FIG. 3, would be stored on the resource-constrained device 101 in the ROM 205. During operation, the CPU 203 operates according to instructions in the various software modules stored in the ROM 205.

FIG. 3 is a block diagram of an exemplary software architecture 300 that one may find implemented on a smart card 101. The software architecture 300 includes several application programs 301. These are loaded onto the smart card by a loader 303. The application programs 301 would typically be loaded into the non-volatile memory 209. However, in other scenarios an application program may be permanently written onto the smart card at manufacture by having it stored in the ROM 205. If the smart card 101 were called upon to execute a program for only one session, it would be possible to have the program loaded in the RAM 207. During execution of an application program, it is also possible that certain portions of the application program are loaded into the RAM 207.

In most embodiments of the invention, the smart card software architecture 300 also includes some system functions 307. System functions 307 may include security functionality, cryptography functionality, and utility libraries that may be called by application programs 301.

The application programs 301 may access functions provided by the smart card system software 307 by issuing calls through an application program interface 309 and may be executed by an interpreter 305.

The system functions 307 may include an initialization sequence 311 that performs certain smart card initialization procedures. These procedures may include the initialization of RAM variables and memory structures, the recovery of transactional operations and data in NVM, the initialization of buffers in RAM and NVM, the reset and initialization of the interpreter state, security checks against possible attack mechanisms, etc. The system functions block 307 also contains an answer-to-reset (ATR) message 313, optionally, a PPS negotiation module 315 which the smart card 101 executes to negotiate protocol and parameter selection (PPS) with the CCID 103, and an APDU processing module for APDU header reception and dispatching of APDU processing.

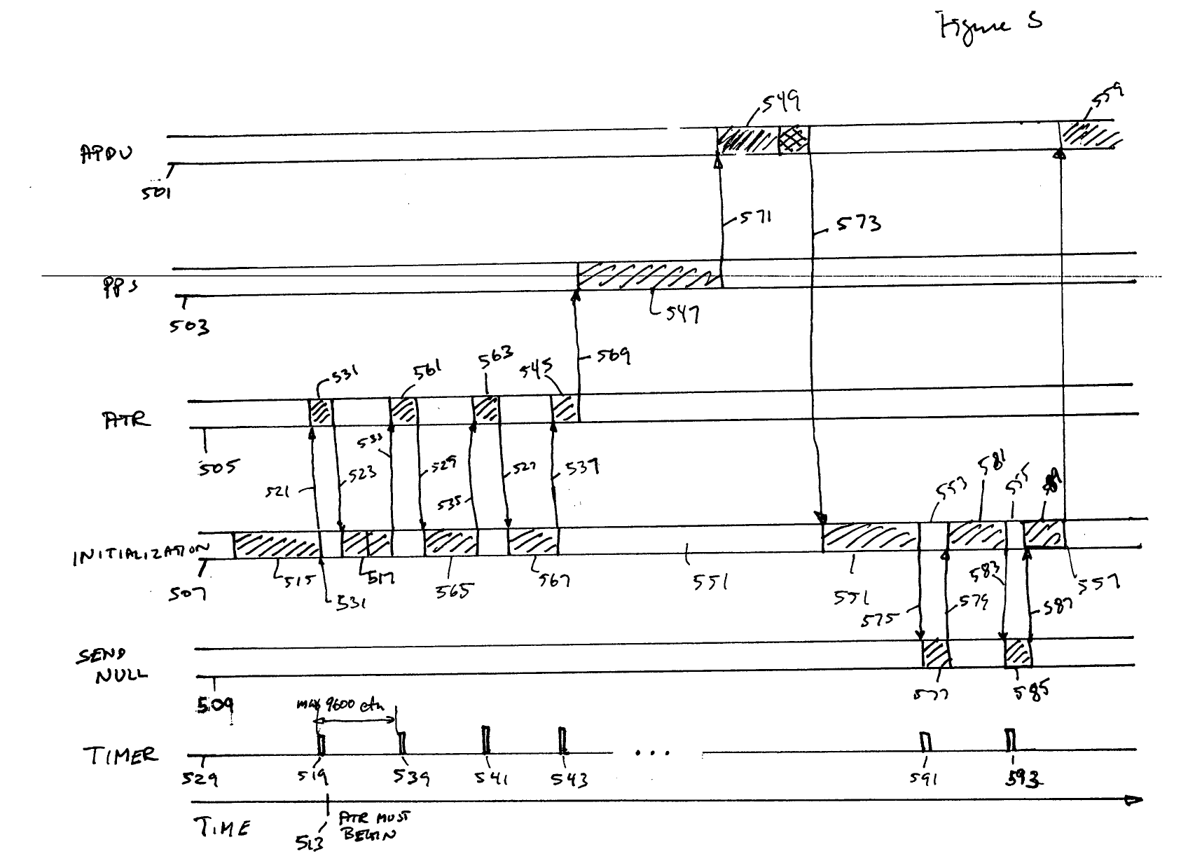

These four modules 311, 313, 315, and 317 are executed after the smart card 101 is powered up. FIG. 4 is an example of a typical timing sequence for these start up processes. ISO-7816 and ISO-14443 both impose a deadline 403 by which time the ATR message must start executing; for ISO-7816 the transmission of the ATR message must begin within 40,000 clock cycles of start up. The start up sequence may start with a first part 401 of the initialization sequence that can be guaranteed to finish execution by the ATR deadline 403. The first part of the initialization would typically only involve fundamental card initialization.

After the first part 401 of the initialization sequence completes, the smart card 101 commences the transmission 405 of the ATR message. The ATR transmission consists of the sequential transmission of a message of up to 33 bytes. In parallel with the ATR transmission 405, a second part 407 of the initialization is executed. Traditionally, this second part is designed to complete prior to the completion of the ATR transmission 405.

When the last character of the ATR message has been transmitted at time 413, the CCID 103 and the smart card 101, optionally, engage in a protocol and parameters selection (PPS) negotiation 409. After conclusion of the ATR message transmission 405, and the optional PPS negotiation 409, the CCID 103 may at any time transmit the first Application Protocol Data Unit (APDU) header which is received by the smart card 101, step 411.

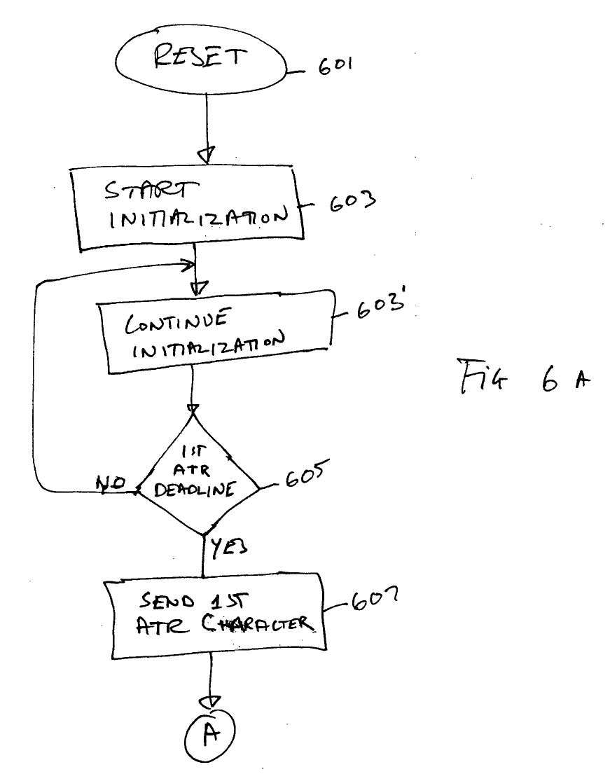

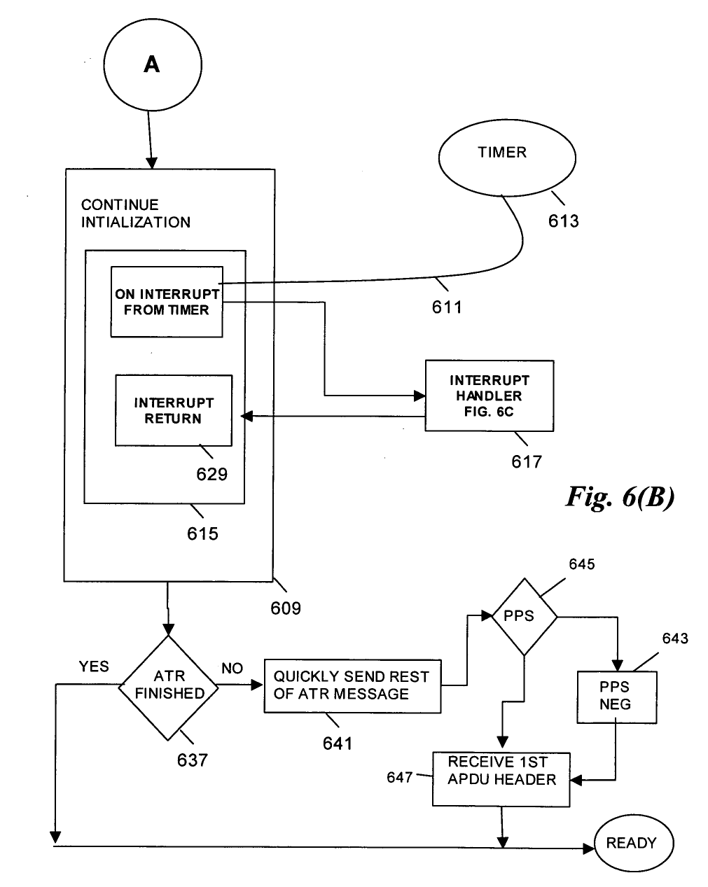

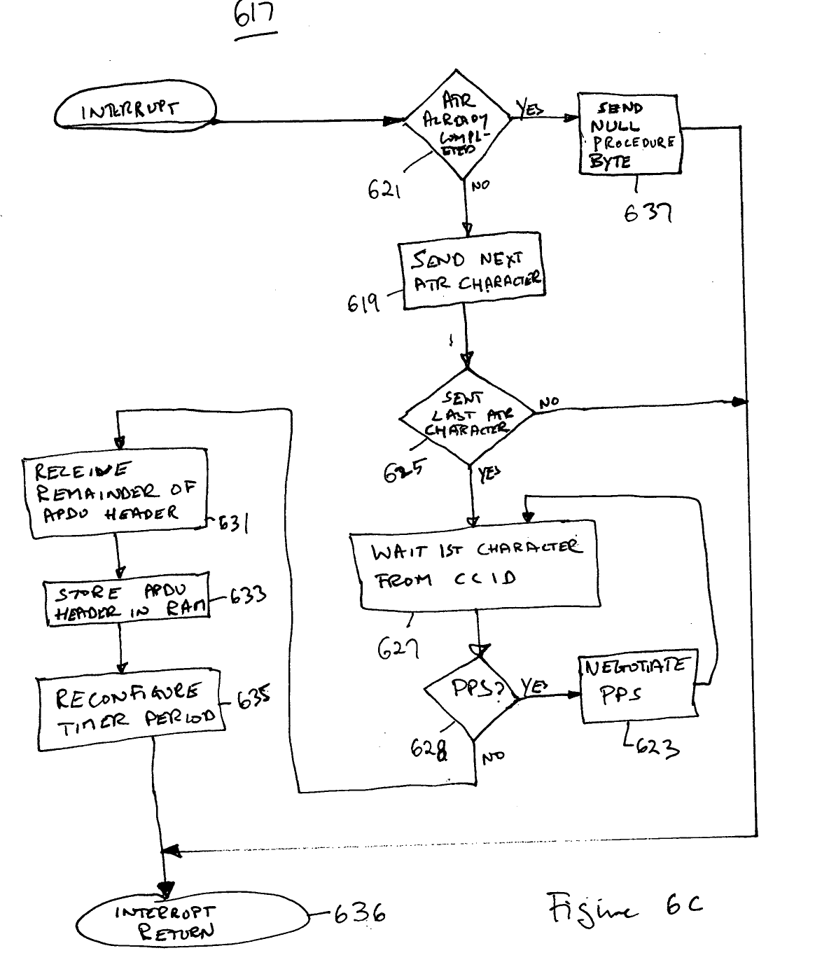

FIG. 5 is a timing sequence diagram of an example of an alternative start up sequence according to the invention. The operation of the invention is further described below in conjunction with the flow-chart shown in FIG. 6. The start up sequence consists of five distinct actions: the initialization 311, the ATR message transmission 313, the optional PPS negotiation 315, receiving and processing a first APDU header and subsequent APDUs, and transmission of null procedure bytes. Each such action, which may be a separate process or part of another process, is represented on FIG. 5 by horizontal timing bars 501 through 509.

In the alternative start up sequence according to the invention, the initialization sequence may be of arbitrary duration while meeting the ISO-7816 and ISO-14443 specifications as to ATR deadlines and the requirement that the smart card be ready to receive and process APDUs after the conclusion of the ATR transmission and optional PPS negotiation by extending the ATR transmission while the initialization process takes place and by placing the initialization process in a wait mode during PPS negotiation. Furthermore, the first APDU header, when received is placed in temporary storage and null procedure bytes are transmitted from the smart card 101 until the initialization process has completed.

In FIG. 5, a hatch marked segment indicates that an action is executing (e.g., segments 515 and 517) and open or clear segments indicated that the action is not executing, either because it has not been started, has completed, or has been temporarily halted.

The smart card 101 starts the start up sequence by performing a first portion of the initialization sequence 311. This first portion is either designed to be performed as a stand-alone unit which may be performed prior to the deadline 513 by which time the ATR message transmission must begin. Alternatively, the initialization process may be interrupted at that time by an external interrupt. That interrupt may be in the form of a signal 519 on a timer operating on the smart card 101.

In either alternative, at some time before the deadline 513, the initialization process is halted (so that one character of the ATR transmission may be transmitted from the smart card 101 to the CCID 103 as illustrated at 531. At that time, control is transferred from the initialization process to the transmission of the ATR message, transition 521. Upon completion of the transmission of the first ATR character and after each subsequent transmission of characters of the ATR message, control is returned to the initialization sequence until such time that either the initialization sequence or the ATR message transmission has completed. These transfers of control are indicated by transitions 523, 525, and 527.

The ISO-7816 and ISO-14443 standards require that the starting leading edges of two consecutive characters of the ATR message transmission must not exceed 9,600 elementary time units (etu) (an etu indicates the space of transmission time occupied by a single bit of data). Therefore, according to the invention, the initialization sequence is again halted at periodic intervals to allow for transmission of subsequent characters of the ATR message such that this standard imposed deadline is adhered to. The transfers of control from the initialization sequence to the transmission of the ATR message are indicated by transitions 533, 535, and 537.

In one embodiment of the invention, a timer with a periodic signal (as illustrated by timeline 529) is used to create an interrupt signal to the initialization sequence. Upon each interrupt signal, e.g., signal pulses 539, 541, and 543, the initialization sequence is interrupted. The corresponding interrupt handler is programmed to either send another character of the ATR message or to transfer control to a process that transmits another character of the ATR message. In a preferred embodiment, the signal pulses of the timer are spaced apart so that the initialization sequence is given as much time as possible before control is transferred to the transmission of the ATR message character while still ensuring that the maximum time allowed between consecutive ATR characters is not exceeded.

In the example of FIG. 5, even with extending the ATR message transmission by allowing the initialization sequence to execute while the ATR message transmission is halted between consecutive ATR message characters, the initialization sequence has not finished by the time of the completion of the ATR message transmission after transmitting a character at block 545. After the ATR message has been completely transmitted, the PPS negotiation optionally takes place or a first APDU header is transmitted 549. While these processes execute, the initialization sequence remains halted 551.

After the first APDU header has been received 549 by the smart card 101, the initialization sequence is again allowed to proceed 551. If the CCID 103 does not receive any communication from the smart card 101 for a period of time, the CCID 103 assumes that the smart card 101 has shut down and would issue a reset command. To ensure that does not occur while the initialization sequence continues to execute 551 after the first APDU header has been received 549, the initialization sequence is periodically halted, 553 and 555, to transmit null procedure bytes.

When the initialization sequence ultimately completes 557, the smart card 101 can continue to process the APDUs received from the CCID 103, block 559.

In the example of FIG. 5, the initialization sequence does not complete prior to the transmission of the last character of the ATR message. If, on the other hand, the initialization sequence completes before the transmission of the last character of the ATR message, the remainder of the ATR message may be transmitted without inter-character delays.

FIG. 6 is a flow chart illustrating the operation of the invention according to one embodiment. The start up sequence of the present invention is invoked upon a reset signal to the card, step 601. Typically a reset would occur at any time the card is powered up. A reset signal may also be transmitted by the CCID 103, for example, after an excessively long idle period.

The smart card 101 then starts the initialization process, step 603. The actual steps involved in the initialization are not relevant here. However, typically the initialization involves the steps necessary to prepare the card for processing. As noted above, the CCID 103 expects an ATR message to be transmitted to it within a specified time period. Thus, the initialization process, at this stage of the start up sequence, would include carrying out those operations necessary to prepare the card for transmitting the ATR message. The initialization process continues, step 603′, until the deadline for transmitting the first character of the ATR message has arrived, step 605. If this condition is checked for explicitly, the procedure merely returns to continue the initialization if the ATR deadline has not yet arrived. Otherwise, the first character of the ATR message is transmitted, step 607.

After the first character of the ATR message has been transmitted, step 607, the initialization continues, step 609. Step 609 is subject to an external interrupt 611 from a timer 613. The interrupt 611 has a bearing on the operation of the initialization when the ATR message transmission has not yet been completed, step 615. Otherwise, the interrupt 611 is ignored (or may be used to interrupt some other procedure of the initialization if useful for another purpose such as signaling the time to send the null procedure bytes after the APDU header has been received).

The timer 613 produces a signal 611 as shown as pulses 519, 539, 541, 543, 591, and 593 in FIG. 5 (that illustration is limited to just a few pulses for illustrative purposes only—in actual implementation the timer 613 would produce a pulse train having a number of pulses corresponding to the ATR length plus and other pulses needed for the initialization sequencing and execution, including signals for the sending of the null procedure bytes).

Upon receipt of the interrupt signal 611, an interrupt handler 617 is invoked. The interrupt handler 617 is illustrated in the flow-chart of FIG. 6c. The interrupt handler either sends the next character of the ATR message or a null procedure byte, depending on whether the ATR message transmission has completed or not. If the ATR message transmission has not completed, step he interrupt handler 617 sends the next ATR character, step 619, which corresponds to block 561, 563, and 545 in FIG. 5.

If the ATR message transmission sent in step 619 was not the last character of the ATR message, step 625, the interrupt handler 617 has finished its operation for this particular ATR message character and returns control to the initialization process, step 636. The initialization process would simply continue processing where it left of when the interrupt occurred.

The immediately-above described sequence (initialization-interrupt-ATR character transmit-interrupt return-continue initialization) corresponds, for example, to the sequences 515-521-531-523-517 and 517-533-561-529-565 etc. of FIG. 5. As can be seen there, after each ATR character has been transmitted while both the initialization and the ATR message have not yet finished, the initialization process is allowed to continue until the next interrupt occurs.

If the ATR message transmission has been completed by the transmission of a character in step 619, as checked in the decision step 625, the procedure continues with either an optional PPS negotiation, step 623, or processing of an APDU header, step 631. The optional nature of the PPS negotiation 623 is illustrated in FIG. 6 by decision box 628. This optional nature of the PPS is under control of the CCID 103, and the smart card 101 must usually operate correctly whether or not the CCID 103 chooses to execute the PPS negotiation. Thus, after determining, in step 625, that the ATR message character sent in 619 was not the last ATR character, the procedure waits for a first character from the CCID 103, step 627, then assess whether it is indicative of a PPS negotiation, step 628. After the optional PPS negotiation or directly after the ATR transmission has been completed, the card receives the first byte of the APDU header from the CCID 103, step 627. Thus, if the first character from the CCID 103 is not indicative of a PPS negotiation, determined in the decision step 628, it is the first character of the APDU header, then the smart card 101 receives the remainder of the APDU header, step 631. The APDU header is stored in memory 633, and, because the timer 613 now will be used to trigger the issuance of null procedure bytes, the timer period is reconfigured to produce pulses that are appropriate for that purpose, step 635. After which steps, the interrupt handler returns control to the initialization process 609, step 636.

The immediately-above described sequence, wherein the ATR message transmission has completed, i.e., initialization-interrupt-ATR character-ATR transmission completed-optional PPS-first APDU header-initialization, corresponds, for example, to the sequence 567-537-545-569-547-571-549-573-551 of FIG. 5. Thus, as can be seen there, while the PPS negotiation 547 takes place and until the first APDU header has been received, block 549 and step 627, the initialization process 609 is on hold, block 551.

When the first APDU header is received, steps 627, 631, and 633, it is simply held in some storage facility of the card until such time as the initialization process has completed, step 633. At that point the CCID 103 is expecting the card to respond to the first APDU header and will wait for that response. Therefore, the smart card 101 can proceed with the balance of the initialization process unimpeded. However, the CCID 103 expects some kind of regular communication from the card 101 to indicate that it is still working. For that purpose, the initialization process periodically transmits null procedure bytes.

If the ATR message transmission has finished, step 621, on a regular interval that is slightly less than the work waiting time for APDU defined by ISO 7816 or ISO 1443, as appropriate, the interrupt handler 617 sends a null procedure byte, step 637, to the CCID 103 to indicate that it is still operating. The timing of sending the null procedure bytes is established by the timer 613. The periodic interruption of the initialization process 609 to send null procedure bytes is illustrated by the sequence 551-575-577-579-581-583-585-587-589 of FIG. 5. After sending the null procedure byte, the interrupt handler 617 returns control to the initialization process 609, step 636.

When the initialization process, step 609, has finished, one of two conditions will be true: either the ATR message transmission has completed (in which case the PPS negotiation has also completed and the first APDU header has been received through the processing that occurred when the last ATR character was transmitted by the interrupt handler 617) or the ATR message transmission has not been completed, step 637. If the ATR message has completed, the card is now ready to continue processing APDUs or take whatever other action it is employed to do, step 639. Otherwise, the balance of the ATR message can now be transmitted without delays, step 641, and the PPS negotiation 645, 643 and the first APDU header may be received 647. The smart card 101 is now ready to continue processing communications with the CCID, step 639.

The technique of the present invention of extending the ATR message transmission to accommodate longer initialization procedure can also be applied during the PPS negotiation 623. A PPS negotiation consists of the CCID 103 transmitting a PPS Request message to the smart card 101. The smart card 101 then responds with a PPS Response message. Like the ATR message, the PPS Response is a string of characters. The transmission of the string of characters can be delayed in the same manner that the ATR message is delayed while allowing the initialization process to execute. The initialization process would be interrupted by the timer, which may be reset to an interval appropriate for the PPS Response transmission, to allow for one character of the PPS Response message to be transmitted.

From the foregoing it will be appreciated that a smart card embodying the startup sequence provided by the present invention represents a significant advance in the art. The present invention provides a novel and advantageous method of extending the ATR message transmission, the PPS response message transmission, if applicable, and optionally, halting the processing of a first APDU header, and using the time gained therefrom to allow smart cards to use initialization sequences of arbitrary duration.

Although specific embodiments of the invention have been described and illustrated, the invention is not to be limited to the specific forms or arrangements of parts so described and illustrated. For example, the invention, while described in the context of smart cards for illustrative purposes, is applicable to other computing devices. The term system software is used throughout this document, however, smart card operating systems and other related modules may be embodied in ROM, non-volatile memory, firmware, programmable logic arrays, etc. In reading the specification and interpreting the claims, all such implementations are to be included in the term system software. Similarly, both in the specification and the claims, the term software taken in isolation should also be interpreted in a broad sense to include firmware, etc. The invention is limited only by the claims.

We claim:

1. A method for operating a smart card during execution of an initialization process to allow concurrent processing of a second process consisting of distinct computational units, comprising:
initiating the second process and executing a unit of the second process;
initiating the initialization process;
periodically pausing the initialization process to allow the second process to process a computational unit before any required deadline for completing the computational unit; and
during the pauses of the initialization process executing the second process processing a computational unit.

2. The method of claim [0023] wherein the second process is the smart card answer to reset (ATR) process and wherein a computational unit is transmission of one byte of data of the ATR process.

3. The method of claim 2 further comprising:
after the ATR process has concluded, pausing the initialization process until after receiving a first Application Protocol Data Unit (APDU) header, and after receiving the first APDU header, continuing the initialization process.

4. The method of claim 2 further comprising:
in response to the ATR process concluding, pausing the initialization process and initiating the protocol and parameters selection (PPS) negotiation process;
in response to concluding the PPS negotiation process, waiting to receive a first Application Protocol Data Unit (APDU) header, and after receiving the first APDU header, continuing the initialization process.

5. The method of claim 3 wherein the step of continuing the initialization process in response to receiving the first APDU header further comprises:
interrupting the initialization process for transmitting null procedure bytes.

6. The method of claim 1 further comprising:
operating a timer on the smart card to produce interrupts at an interval such that a clock edge of the timer is timed such that a computational unit executed following the clock edge will complete prior to the deadline of the computational unit.

7. The method of claim 6 wherein the timer is a hardware timer producing a signal at an interval sufficient to allow a computational unit to conclude between the signal occurrence and the arrival of a defined deadline for the computational unit.

8. The method of claim 6 wherein the second process is the smart card answer to reset (ATR) process and wherein a computational unit is transmission of one byte of data of the ATR process and the deadline is the required time by which time the one byte of data must follow an immediately preceding byte of data and the byte of data is transmitted following the signal of the timer.

9. The method of claim 8 wherein the timing of the signal of the timer is specified to allow the ATR to send a byte before the deadline.

10. The method of claim 6 wherein the second process is the smart card PPS response message and wherein a computational unit is transmission of one byte of data of the PPS response message and the deadline is the required time by which time the one byte of data must follow an immediately preceding byte of data and the byte of data is transmitted following the signal of the timer.

11. The method of claim 10 wherein the timing of the signal of the timer is specified to allow the PPS response message transmission to send a byte before the deadline.

12. The method of claim 6 wherein the second process transmits null procedure bytes and wherein a computational unit is transmission of one null procedure byte and the deadline is the required time by which time the one byte of data must follow an immediately preceding byte of data and the byte of data is transmitted following the signal of the timer.

13. The method of claim 10 wherein the timing of the signal of the timer is specified to allow the transmission to send a byte before the deadline.

14. A method for operating a smart card to operate multiple sequences in parallel, comprising:
(a) initiating a first sequence of computational units;
(b) after each computational unit, transferring control to a second sequence;
(c) after processing the second sequence until a defined event and upon the occurrence of the defined event transferring control back to the first sequence;
(d) repeating steps (b) and (c) until either sequence has concluded.

15. The method of claim 14, further comprising:
(e) if the first sequence concludes before the second sequence, halting the second sequence and starting a third sequence and restarting the second sequence after the conclusion of the third sequence.

16. The method of claim 15, wherein the first sequence is an Answer-to-Reset (ATR) negotiation sequence, the second sequence is an initialization sequence, and the third sequence is a protocol and parameters selection (PPS) negotiation process.

17. The method of claim 14, wherein the first sequence is an protocol and parameter selection (PPS) response message transmission.

18. The method of claim 16, further comprising:
restarting the initialization sequence after receipt of a first Application Protocol Data Unit (APDU) header, and periodically pausing the initialization sequence to send a null procedure byte.

19. The method of claim 14, wherein the defined event is an interrupt from a timer operating on the smart card to cause an interrupt signal at defined intervals.

20. A smart card having the capability during execution of an initialization process to allow concurrent processing of a second process consisting of distinct computational units, comprising:
logic to initiate the second process and to execute a unit of the second process;
logic to initiate the initialization process;
logic to periodically pause the initialization process to allow the second process to process a computational unit before any required deadline for completing the computational unit; and
logic to executing the second process processing a computational unit during the pauses of the initialization process.

21. The smart card of claim 20 wherein the second process is the smart card answer to reset (ATR) process and wherein a computational unit is transmission of one byte of data of the ATR process.

22. The smart card of claim 21 further comprising:
logic to pause the initialization process until after receiving a first Application Protocol Data Unit (APDU) header if the ATR process has concluded, and after receiving the first APDU header, to continue the initialization process.

23. The smart card of claim 21 further comprising:
logic operable to, in response to the ATR process concluding, pause the initialization process and to initiate the protocol and parameters selection (PPS) negotiation process;
logic operable to, in response to concluding the PPS negotiation process, waiting to receive a first Application Protocol Data Unit (APDU) header, and after receiving the first APDU header, continuing the initialization process.

24. The smart card of claim 22 wherein the logic to continue the initialization process in response to receiving the first APDU header further comprises:
logic to interrupt the initialization process for transmitting null procedure bytes.

25. The smart card of claim 20 wherein the second process is the smart card protocol and parameter selection (PPS) response message transmission and wherein a computational unit is transmission of one byte of data of the PPS response message.

26. The smart card of claim 20 wherein the second process is a process to transmit null procedure bytes and wherein a computational unit is transmission of one null procedure byte.

27. The smart card of claim 20 further comprising:
a timer on the smart card to produce interrupts at an interval such that a clock edge of the timer is timed such that a computational unit executed following the clock edge will complete prior to the deadline of the computational unit.

28. The smart card of claim 27 wherein the timer is a hardware timer producing a signal at an interval sufficient to allow a computational unit to conclude between the signal occurrence and the arrival of a defined deadline for the computational unit.

29. The smart card of claim 27 wherein the second process is the smart card answer to reset (ATR) process and wherein a computational unit is transmission of one byte of data of the ATR process and the deadline is the required time by which time the one byte of data must follow an immediately preceding byte of data and the byte of data is transmitted following the signal of the timer.

30. The smart card of claim 29 wherein the timing of the signal of the timer is specified to allow the ATR process to send a byte before the deadline.

31. A smart card capable to operate multiple sequences in parallel, comprising logic to:
(a) initiate a first sequence of computational units;
(b) after each computational unit, transfer control to a second sequence;
(c) after processing the second sequence until a defined event and upon the occurrence of the defined event, transfer control back to the first sequence;
(d) repeat steps (b) and (c) until either sequence has concluded.

32. The smart card of claim 31, further comprising logic to:
(e) if the first sequence concludes before the second sequence, halt the second sequence and starting a third sequence and restart the second sequence after the conclusion of the third sequence.

33. The smart card of claim 32, wherein the first sequence is an Answer-to-Reset (ATR) negotiation sequence, the second sequence is an initialization sequence, and the third sequence is a protocol and parameters selection (PPS) negotiation process.

34. The smart card of claim 33, further comprising logic to:
restart the initialization sequence after receipt of a first Application Protocol Data Unit (APDU) header, and
periodically pausing the initialization sequence to send a null procedure byte.

35. The smart card of claim 31, wherein the defined event is an interrupt from a timer operating on the smart card to cause an interrupt signal at defined intervals.
